(19) United States
(12) Patent Application Publication
(10) Pub. No.: US 2023/0274874 A1
(43) Pub. Date: Aug. 31, 2023

(54) INDUCTOR DEVICE

(71) Applicant: Murata Manufacturing Co., Ltd., Nagaokakyo-shi (JP)

(72) Inventor: Takeshi INAO, Nagaokakyo-shi (JP)

(21) Appl. No.: 18/143,237

(22) Filed: May 4, 2023

Related U.S. Application Data
(63) Continuation of application No. PCT/JP2021/042779, filed on Nov. 22, 2021.

(30) Foreign Application Priority Data
Dec. 7, 2020 (JP) 2020-202617

(51) Int. Cl. H01F 27/28; H01F 27/34; H01F 27/29

(52) U.S. Cl. CPC H01F 27/2828; H01F 27/34; H01F 27/29; H01F 17/02

(57) ABSTRACT

An inductor device includes a substrate, first and second coils in the substrate and connected in series, and first and second terminals. The first terminal is connected to the first coil, and the second terminal is connected to the second coil. Each of the first and second coils is a spiral or helical coil wound with more than one turn. At least a portion of the first coil overlaps at least a portion of the second coil when seen in a plan view from a direction perpendicular or substantially perpendicular of the substrate. A direction of a magnetic field generated by the first coil is opposite to a direction of a magnetic field generated by the second coil.

### CROSS REFERENCE TO RELATED APPLICATIONS

This application claims the benefit of priority to Japanese Patent Application No. 2020-202617 filed on Dec. 7, 2020 and is a Continuation Application of PCT Application No. PCT/JP2021/042779 filed on Nov. 22, 2021. The entire contents of each application are hereby incorporated herein by reference.

### BACKGROUND OF THE INVENTION

### 1. Field of the Invention

The present disclosure relates to an inductor device, and, in particular, to a structure to reduce magnetic flux leakage from an inductor device.

### 2. Description of the Related Art

Inductor elements in which a coil conductor having a flat spiral shape is formed on or in a substrate are disclosed in Japanese Unexamined Patent Application Publication Nos. 2004-128525, 2000-232202, 7-183749, and 2003-347123.

When an electric current flows in the flat inductor element disclosed in Japanese Unexamined Patent Application Publication No. 2004-128525, Japanese Unexamined Patent Application Publication No. 2000-232202, Japanese Unexamined Patent Application Publication No. 7-183749, and Japanese Unexamined Patent Application Publication No. 2003-347123, a magnetic field is generated around the conductor, and a magnetic field is generated in the winding-axis direction of the coil conductor (that is, the normal direction of the substrate). When another electronic component, wiring, or the like is disposed around the inductor device, the magnetic field generated by inductor device may cause magnetic interference with such a component, and the magnetic interference may become a factor in generation of noise.

### SUMMARY OF THE INVENTION

Preferred embodiments of the present invention provide inductor devices each with reduced magnetic flux leakage.

An inductor device according to a preferred embodiment of the present disclosure includes a substrate, a first coil and a second coil in the substrate, a first terminal, and a second terminal. The first coil and the second coil are connected in series. The first terminal is connected to the first coil, and the second terminal is connected to the second coil. Each of the first coil and the second coil is a spiral or helical coil wound with more than one turn. At least a portion of the first coil overlaps at least a portion of the second coil when seen in a plan view from a direction perpendicular or substantially perpendicular to the substrate. A direction of a magnetic field generated by the first coil is opposite to a direction of a magnetic field generated by the second coil.

With the inductor devices according to preferred embodiments of the present disclosure, two coils that are connected in series overlap each other when seen in a plan view, and the directions of magnetic fields generated by the coils are opposite to each other. Thus, it is possible to reduce magnetic flux leakage to the outside, because the magnetic fields generated by the coils cancel each other out.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of an inductor device according to a preferred embodiment of the present invention.

FIG. 2 is a sectional see-through view of the inductor device of FIG. 1.

FIG. 3 illustrates magnetic fluxes generated by coils in the inductor device of FIG. 1.

FIG. 4 illustrates a first example of a coil connection.

FIG. 5 illustrates a second example of a coil connection.

FIG. 6 illustrates a third example of a coil connection.

FIG. 7 illustrates a fourth example of a coil connection.

FIGS. 8A and 8B illustrate coil units of an inductor device according to a preferred embodiment and an inductor device according to a comparative example.

FIG. 9 illustrates examples of magnetic flux density distributions in an inductor device according to a preferred embodiment and an inductor device according to a comparative example.

FIG. 10 illustrates the relationship between the distance between coils and the Q factor.

FIG. 11 illustrates the relationship between the distance between adjacent conductors of a coil and the Q factor.

FIG. 12 is a sectional view of a circuit module in which an inductor device according to a modification of a preferred embodiment of the present invention is provided.

### DETAILED DESCRIPTION OF THE PREFERRED EMBODIMENTS

Hereafter, preferred embodiments of the present invention will be described in detail with reference to the drawings. The same or corresponding portions in the drawings will be denoted by the same reference numerals and description of such portions will not be repeated.

### Configuration of Inductor Device

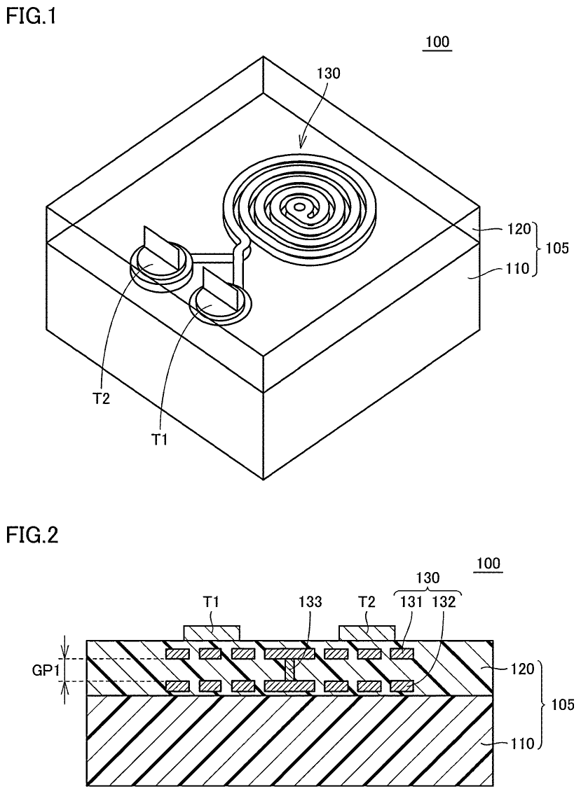

FIG. 1 is an external perspective view of an inductor device 100 according to a preferred embodiment of the present invention. FIG. 2 is a sectional see-through view of the inductor device 100. The inductor device 100 is used, for example, in a communication apparatus for transmitting and receiving a radio-frequency signal.

Referring to FIGS. 1 and 2, the inductor device 100 includes a substrate 105 including a support substrate 110 and a dielectric layer 120, a coil unit 130, and terminals T1 and T2. The support substrate 110 is, for example, a semiconductor substrate made of silicon (Si) or the like. The dielectric layer 120 is, for example, a multilayer substrate in which a plurality of dielectrics made of low temperature co-fired ceramics (LTCC) or resins are stacked. The coil unit 130 is disposed in inner layers of the dielectric layer 120. In FIG. 1, the dielectric layer 120 is illustrated transparently for ease of understanding the coil unit 130 therein.

The coil unit 130 is made of a conductive material such as, for example, copper or aluminum. The coil unit 130 includes two coils 131 and 132 in each of which a conductor is wound with more than one turn from the outer periphery to the inner periphery, and a connection member 133 connecting the coils 131 and 132 in series. In the example illustrated in FIGS. 1 and 2, each of the coils 131 and 132 is a spiral coil whose conductor is disposed in the same layer in the dielectric layer 120. However, each coil may be a helical coil whose conductor becomes offset in the layer-stacking direction of the dielectric layer 120 from the outer terminal end towards the inner terminal end.

The coil 131 and the coil 132 are spaced apart by a distance GP1 in the layer-stacking direction of the dielectric layer 120. The distance GP1 may have an allowance of, for example, about ±5% over the entire coil. The inner terminal end of the coil 131 is connected to the inner terminal end of the coil 132 through the connection member 133. The outer terminal end of the coil 131 is connected to the terminal T1 disposed on the upper surface of the dielectric layer 120. The outer terminal end of the coil 132 is connected to the terminal T2 disposed on the upper surface of the dielectric layer 120.

In the example illustrated in FIGS. 1 and 2, the coils 131 and 132 have the same or substantially the same circular or substantially circular outer shape, and are disposed so as to overlap each other when seen in a plan view from the normal direction of the dielectric layer 120. The shapes of the coils 131 and 132 are not limited to a circle and may be, for example, a polygon, an ellipse, a semicircle, or the like, and the coils 131 and 132 may have slight differences in shape and/or dimensions. It is sufficient that at least portions of the coils 131 and 132 overlap when seen in a plan view.

When an electric current flows in such an inductor device, a magnetic field is generated around the conductor, and a magnetic field is generated by each coil in the winding-axis direction (that is, the layer-stacking direction of the substrate). When another electronic component, wiring, or the like is disposed around the inductor device, the magnetic field generated by inductor device may cause magnetic interference with such a component, and the magnetic interference may become a factor in the generation of noise or a malfunction of an apparatus. If the inductor device is disposed at a distance from other components in order to avoid the magnetic interference, the size of the apparatus becomes large and obstructs or prevents reduction in size.

In the inductor device 100 according to the present preferred embodiment, as described above, the two coils 131 and 132 are connected to each other at the inner terminal ends thereof and are disposed so that at least portions thereof overlap when seen in a plan view from the direction perpendicular or substantially perpendicular of the substrate. When an electric current flows from the terminal T1 toward the terminal T2, the electric current flows from the outer terminal end to the inner terminal end in the coil 131, and the electric current flows from the inner terminal end to the outer terminal end in the coil 132. Since the winding directions of the coils 131 and 132 are the same, the direction of a magnetic field generated by the coil 131 and the direction of a magnetic field generated by the coil 132 are opposite to each other.

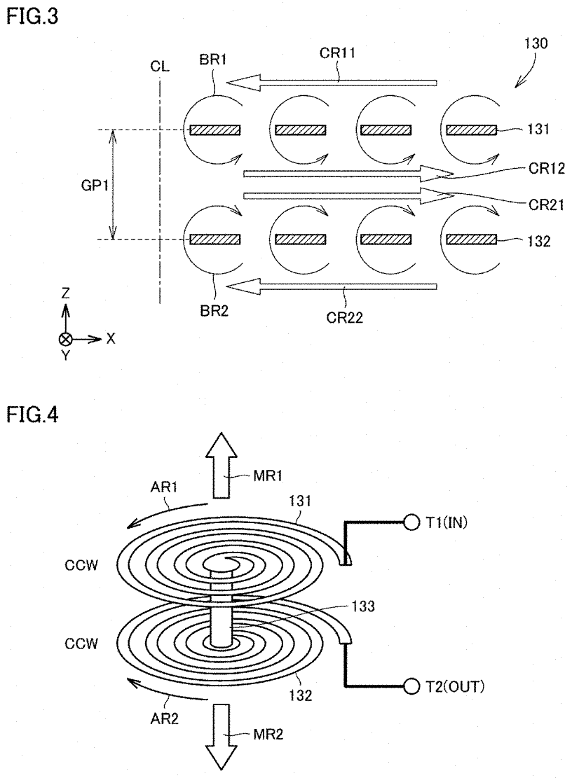

FIG. 3 illustrates magnetic fluxes generated by the coils 131 and 132 of the inductor device 100 of FIG. 1. FIG. 3 is a sectional view of a half of the coils 131 and 132 on one side of the center (center line CL). In FIG. 3, the radial direction is indicated by the X axis, and the winding-axis direction of the coil is indicated by the Z axis.

Referring to FIG. 3, when an electric current flows from the terminal T1 toward the terminal T2 as described above, the electric current flows in the negative Y-axis direction in each conductor of the coil 131 in the portion illustrated in FIG. 3. Then, a magnetic flux is generated in the direction of an arrow BR1 around each conductor of the coil 131. Between adjacent conductors of the coil 131, a magnetic flux from a conductor on the outer peripheral side is generated in the negative Z-axis direction, and a magnetic flux from a conductor on the inner peripheral side is generated in the positive Z-axis direction. Therefore, between the conductors, the magnetic flux generated from the conductor on the outer peripheral side and the magnetic flux generated from the conductor on the inner peripheral side cancel each other out. As the entirety of the coil 131, a magnetic flux in the negative Z-axis direction is generated, because the cancellation of the magnetic fluxes does not occur at a central portion of the coil and the coil length becomes larger as the conductor is positioned further on the outer peripheral side. On the upper side (facing in the positive Z-axis direction) of the coil 131, a magnetic flux is generated in the negative X-axis direction, that is, in a radial direction from the outer periphery toward the coil center (an arrow CR11 of FIG. 3). On the other hand, on the lower side (facing in the negative Z-axis direction) of the coil 131, a magnetic flux is generated in the positive X-axis direction, that is, in a radial direction from the coil center towards the outer periphery (an arrow CR12 of FIG. 3).

On the other hand, regarding the coil 132, a magnetic flux is generated in a direction opposite to that of the coil 131, because an electric current flows in the positive Y-axis direction in each conductor. To be more specific, a magnetic flux is generated in the direction of an arrow BR1 around each conductor of the coil 132, and, in the Z-axis direction, a magnetic flux is generated in the positive Z-axis direction as the entirety of the coil 132. A magnetic flux is generated in the positive X-axis direction (an arrow CR21 of FIG. 3) on the upper side of the coil 132, and a magnetic flux is generated in the negative X-axis direction (an arrow CR22 of FIG. 3) on the lower side of the coil 132.

In this way, by disposing the coil 131 and the coil 132 close to each other in the winding-axis direction, regarding the Z-axis direction, a magnetic field generated by one of the coils is cancelled out by a magnetic flux generated by the other coil. On the other hand, regarding the X-axis direction (radial direction), although magnetic fluxes are generated in the same direction between the coils, since the distance GP1 between the coils is small, magnetic fluxes on the upper sides of the coils interfere with each other and magnetic fluxes on the lower sides of the coils interfere with each other, and portions of the magnetic fluxes cancel each other out. Accordingly, it is possible to reduce a magnetic flux that leaks to the outside from the inductor device 100 by disposing the two spiral coils, which generate magnetic fields in directions opposite to each other, close to each other in the winding-axis direction as in the inductor device 100 according to the present preferred embodiment. Thus, it is possible to reduce or prevent an effect of magnetic flux leakage on an electronic component and wiring around the inductor device and to reduce the size of the entirety of an apparatus in which the inductor device is disposed.

### Connection Configuration

Next, referring to FIGS. 4 to 7, variations in connection of the coils 131 and 132 in the inductor device 100 will be described. In the descriptions of FIGS. 4 to 7, magnetic fields generated in the winding-axis direction will be mainly described.

In the example illustrated in FIG. 4, both of the coil 131 and the coil 132 are wound in the counterclockwise (CCW) direction from the outer terminal end toward the inner terminal end, and the inner terminal ends are connected to each other through the connection member 133. The connection member 133 is a linear via extending in the layer-stacking direction of the substrate. With such a connection configuration, when an electric current flows from the terminal T1 to the terminal T2, the electric current flows through the coil 131 in the direction of an arrow AR1 of FIG. 4 (that is, the CCW direction). Thus, a magnetic field is generated upward (the direction of an arrow MR1) from the coil 131. On the other hand, the electric current flows through the coil 132 in the direction of an arrow AR2 of FIG. 4 (that is, the clockwise (CW) direction) from the inner terminal end toward the outer terminal end. Thus, a magnetic field is generated downward (the direction of an arrow MR2) from the coil 132. Accordingly, the magnetic field generated by one of the coils is cancelled out by the magnetic field generated by the other coil.

In the example illustrated in FIG. 5, both of the coil 131 and the coil 132 are wound in the counterclockwise (CCW) direction from the outer terminal end toward the inner terminal end, in the same way as in FIG. 4. However, the outer terminal ends of the coil 131 and the coil 132 are connected to each other through a connection member 133A. The inner terminal end of the coil 131 is connected to the terminal T1, and the inner terminal end of the coil 132 is connected to the terminal T2.

With such a connection configuration, when an electric current flows from the terminal T1 to the terminal T2, the electric current flows through the coil 131 in the direction of an arrow AR1A of FIG. 5 (the CW direction), and the electric current flows through the coil 132 in the direction of an arrow AR2A of FIG. 5 (the CCW direction). Therefore, a magnetic field is generated downward (the direction of an arrow MR1A) from the coil 131, and a magnetic field is generated upward (the direction of an arrow MR2A) from the coil 132. Accordingly, the magnetic field generated by one of the coils is cancelled out by the magnetic field generated by the other coil.

In FIGS. 4 and 5, the winding directions of both of the coils 131 and 132 may be the CW direction. In this case, the direction of a magnetic field generated by each coil is opposite to that in the figures.

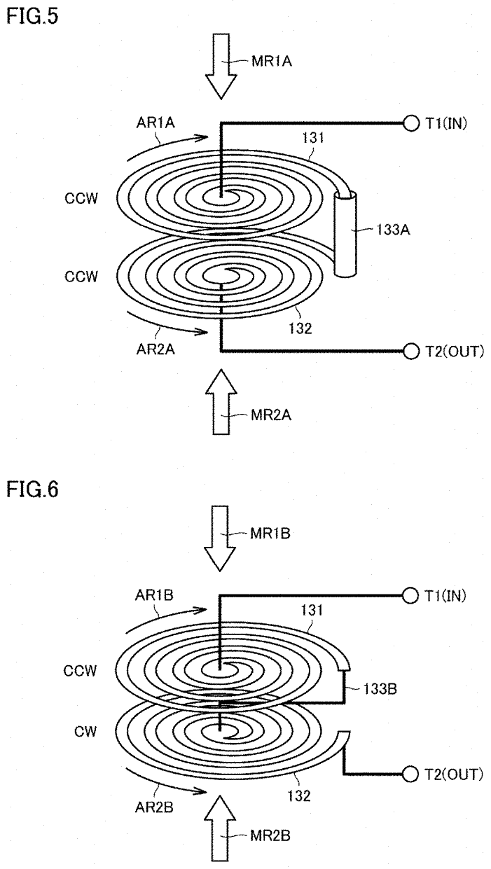

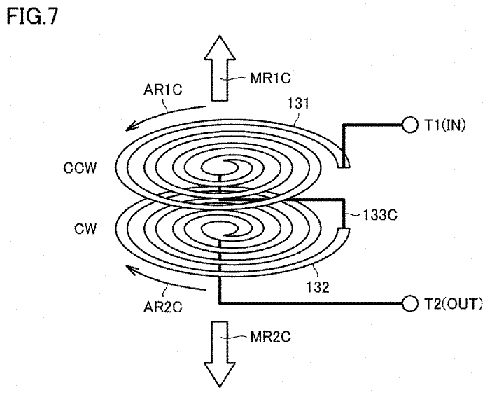

FIGS. 6 and 7 illustrate examples in which the winding directions of the coil 131 and the coil 132 are opposite to each other.

In the example illustrated in FIG. 6, the coil 131 is wound in the CCW direction from the outer terminal end toward the inner terminal end. On the other hand, the coil 132 is wound in the CW direction from the outer terminal end toward the inner terminal end. The inner terminal end of the coil 131 is connected to the terminal T1, and the outer terminal end of the coil 131 is connected to the inner terminal end of the coil 132. The outer terminal end of the coil 132 is connected to the terminal T2.

With such a connection configuration, when an electric current flows from the terminal T1 to the terminal T2, the electric current flows through the coil 131 in the direction of an arrow AR1B of FIG. 6 (the CW direction), and the electric current flows through the coil 132 in the direction of an arrow AR2B of FIG. 6 (the CCW direction). Therefore, a magnetic field is generated downward (the direction of an arrow MR1B) from the coil 131, and a magnetic field is generated upward (the direction of an arrow MR2B) from the coil 132. Accordingly, the magnetic field generated by one of the coils is cancelled out by the magnetic field generated by the other coil.

In the example illustrated in FIG. 7, the coil 131 is wound in the CCW direction from the outer terminal end toward the inner terminal end, and the coil 132 is wound in the CW direction from the outer terminal end toward the inner terminal end. The outer terminal end of the coil 131 is connected to the terminal T1, and the inner terminal end of the coil 131 is connected to the outer terminal end of the coil 132. The inner terminal end of the coil 132 is connected to the terminal T2.

With such a connection configuration, when an electric current flows from the terminal T1 to the terminal T2, the electric current flows through the coil 131 in the direction of an arrow AR1C of FIG. 7 (the CCW direction), and the electric current flows through the coil 132 in the direction of an arrow AR2C of FIG. 7 (the CW direction). Therefore, a magnetic field is generated upward (the direction of an arrow MR1C) from the coil 131, and a magnetic field is generated downward (the direction of an arrow MR2C) from the coil 132. Accordingly, the magnetic field generated by one of the coils is cancelled out by the magnetic field generated by the other coil.

### Effect of Reducing Magnetic Flux Leakage

Next, an effect of reducing magnetic flux leakage from the inductor device 100 according to the present preferred embodiment will be described by using a comparative example.

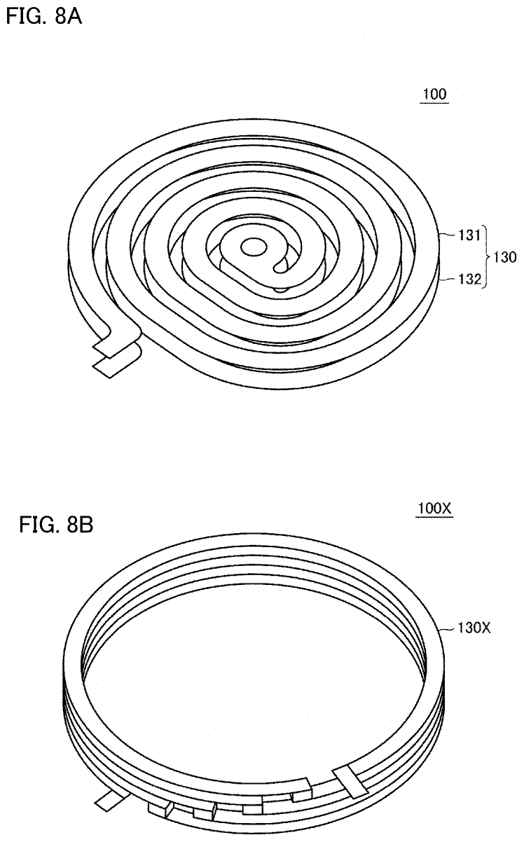

FIGS. 8A and 8B illustrate coil units of the inductor device 100 according to the present preferred embodiment and an inductor device 100X according to the comparative example. FIG. 8A illustrates only the coil unit 130 of FIG. 1. As described above, the coil unit 130 has a configuration such that the two spiral coils 131 and 132 having the same or substantially the same shape are spaced away from each other in the winding-axis direction.

FIG. 8B illustrates a coil unit 130X of the inductor device 100X according to the comparative example. The coil unit 130X according to the comparative example is a helical coil in which a plurality of coils having the same diameter are connected through vias in the layer-stacking direction of the dielectric layer. When an electric current flows in the coil unit 130X, magnetic fields are generated in the same direction from the plurality of coils, because the coils are wound in the same direction in the coil unit 130X.

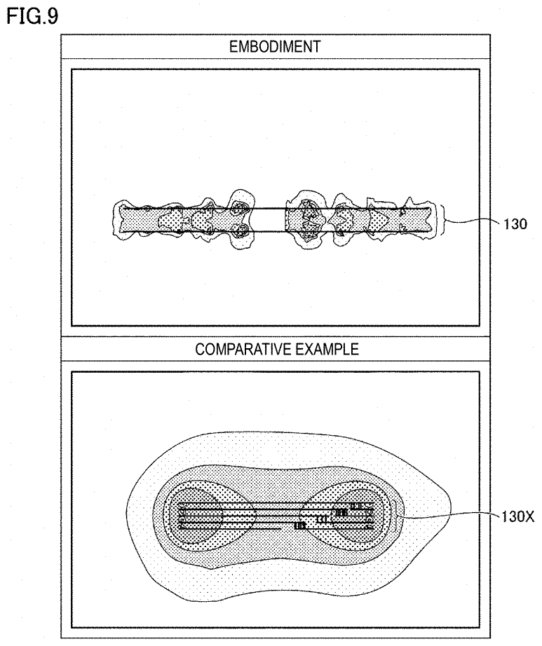

FIG. 9 illustrates an example of the result of simulating the magnetic-field-density distributions of the inductor device 100 according to the present preferred embodiment and the inductor device 100X according to the comparative example. In FIG. 9, magnetic flux density in a section including the winding axis is represented by shading density, and a portion having high magnetic flux density is illustrated with dense hatching. It can be seen from FIG. 9 that, with the coil unit 130X according to the comparative example, a region close to the conductor and having high magnetic flux density is larger than that of the coil unit 130 according to the preferred embodiment, and the magnetic flux is distributed widely to a portion spaced away from the coil unit 130X. On the other hand, with the coil unit 130 according to the present preferred embodiment, a region having high magnetic flux density is limited to the close vicinity of the conductor. Moreover, the magnetic flux is confined in a region between the two coils 131 and 132, and the distribution of the magnetic flux is more restricted than that of the comparative example.

In this way, with the inductor device 100 according to the present preferred embodiment, it is possible to reduce or prevent an effect on an electronic component and wiring around the inductor device 100, because it is possible to reduce a magnetic flux that leaks to the outside from the coil unit 130. Moreover, it is possible to reduce the size of the entirety of an apparatus, because, for the above-described reasons, it is possible to reduce the distance between the inductor device and an electronic component and wiring around the inductor device.

In general, the intensity of a magnetic field generated by a coil decreases with increasing distance from the coil. Therefore, it is preferable that the distance GP1 between the coils 131 and 132 is as short as possible in order to increase the effect of canceling out magnetic fields generated by the coils. On the other hand, if the distance GP1 between the coils is reduced, the Q factor may decrease, because magnetic fluxes on the upper side of the coil 131 and on the lower side of the coil 132 are reduced.

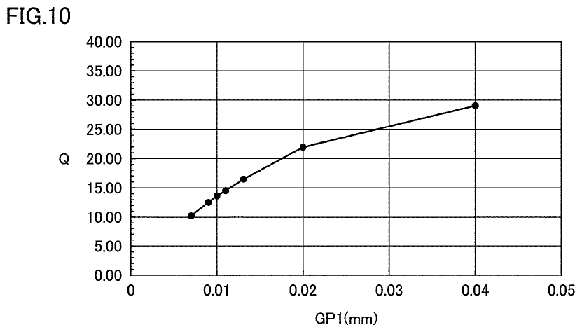

FIG. 10 illustrates the relationship between the distance GP1 between the coils and the Q factor when a radio-frequency signal in a 3 GHz band is input. In FIG. 10, the horizontal axis represents the distance GP1 between the coil 131 and the coil 132, and the vertical axis represents the Q factor. As illustrated in FIG. 10, the Q factor decreases as the distance GP1 between the coils decreases. In the example of the present preferred embodiment, the distance GP1 needs to be, for example, about 0.01 mm or larger, because a Q factor of about 13.0 or higher is required. Although not illustrated in FIG. 10, when the distance GP1 becomes larger than about 0.1 mm, the effect of cancelling out magnetic fields decreases and the distribution of the magnetic flux becomes wider. Therefore, it is preferable that the distance GP1 between the coils is, for example, in the range of about 0.01 mm to about 0.1 mm (about 0.01 mm≤GP1≤about 0.1 mm).

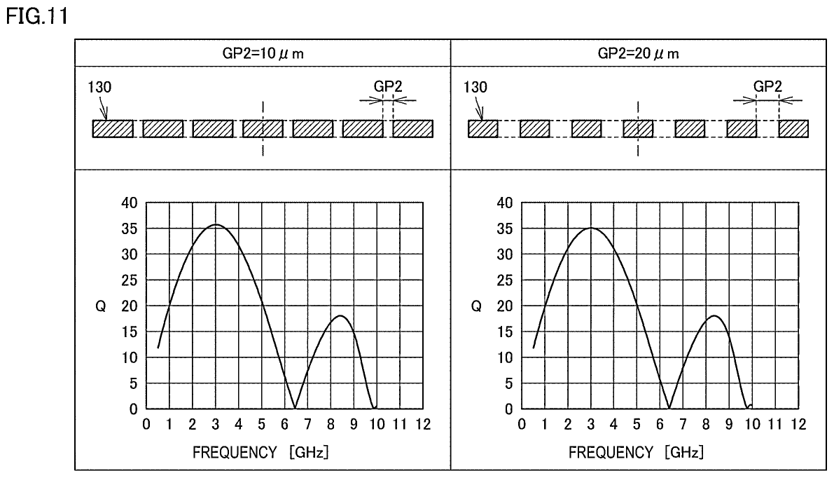

In a spiral coil such as the coil 131 or 132, the distance between adjacent conductors in each coil may have an effect on the Q factor. FIG. 11 illustrates the relationship between the distance GP2 between adjacent conductors of each coil and the Q factor in the inductor device 100 according to the preferred embodiment. FIG. 11 shows the Q factors when the distance GP2 between conductors of the coil is about 10 pm and when the distance GP2 is about 20 μm.

As illustrated in FIG. 11, it can be understood, from the peaks of the Q factor around 3 GHz for which the inductor device 100 is used, that the Q factor tends to decrease as the distance GP2 between conductors increases. This is because it becomes easier for a magnetic flux to leak to the outside of the inductor device 100 as the distance GP2 between conductors increases. In the present preferred embodiment, it is preferable that the distance GP2 between conductors is, for example, in the range of about 0.01 mm or smaller (GP2≤about 0.01 mm) in order to obtain a preferable Q factor. With such a configuration, it is possible to make the peak of the Q factor higher than about 35.0. To be specific, as illustrated in FIG. 10, when a radio-frequency signal in the 3 GHz band is input, the peak of the Q factor is higher than about 35.0 when the distance GP2 between conductors is about 0.01 mm and the peak of the Q factor is lower than about 35.0 when the distance GP2 between conductors is about 0.02 mm. Accordingly, it is possible to obtain a better Q factor by reducing the distance GP2 between conductors in each coil. However, for convenience of manufacture, it is preferable that the distance GP2 between conductors is, for example, about 0.002 mm or larger.

### Modification

In the preferred embodiment described above, the inductor device is provided as an independent individual element. However, an inductor device according to the present invention may be provided in a wiring layer in the substrate.

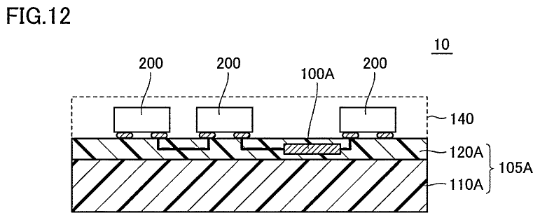

FIG. 12 is a sectional view of a circuit module 10 in which an inductor device 100A according to a modification of a preferred embodiment of the present invention is provided. The circuit module 10 includes a substrate 105A and a plurality of electronic components 200 mounted on the substrate 105A. The substrate 105A includes a support substrate 110A and a wiring layer 120A provided on the support substrate 110A. Wiring for connecting the electronic components 200 to each other is provided in the wiring layer 120A. The inductor device 100A is provided in the wiring layer 120A. The electronic components 200 mounted on the wiring layer 120A may be molded with, for example, a resin 140.

As with the inductor device 100 described in the preferred embodiment described above, the inductor device 100A is configured so that two spiral coils connected in series overlap each other when seen in a plan view and the directions of magnetic fields generated by the coils are opposite to each other.

In the circuit module 10, if a magnetic flux leaks from the inductor device, the magnetic flux tends to have an effect on the electronic components 200, because the electronic components 200 are mounted on upper portions of the wiring layer 120A. Therefore, by causing magnetic fields generated by the two coils to cancel each other out as in the inductor device 100A, it is possible to reduce a magnetic flux that leaks to the outside and to reduce or prevent an effect on the electronic components 200.

Moreover, by providing the inductor device 100A in the wiring layer 120A in the substrate, it is also possible to reduce the size of the circuit module 10 compared with a case where an individual inductor device is mounted.

In the example described above, the coil unit includes two coils. However, the coil unit may include three or more coils, as long as magnetic fields generated by the coils can cancel each other out. It is preferable that the coil unit includes an even number of coils.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inductor device comprising:
a substrate;
a first coil and a second coil in the substrate and connected in series;
a first terminal connected to the first coil; and
a second terminal connected to the second coil; wherein
each of the first coil and the second coil is a spiral coil or a helical coil wound with more than one turn;
at least a portion of the first coil overlaps at least a portion of the second coil when seen in a plan view from a direction perpendicular or substantially perpendicular to the substrate; and
a direction of a magnetic field generated by the first coil is opposite to a direction of a magnetic field generated by the second coil.

2. The inductor device according to claim 1, wherein a distance between the first coil and the second coil in the direction perpendicular or substantially perpendicular to the substrate is about 0.1 mm or smaller.

3. The inductor device according to claim 2, wherein the distance between the first coil and the second coil in the direction perpendicular or substantially perpendicular to the substrate is about 0.01 mm or larger.

4. The inductor device according to claim 1, wherein the first coil and the second coil are wound in the same direction when seen in a plan view from the direction perpendicular or substantially perpendicular to the substrate.

5. The inductor device according to claim 4, wherein
each of the first coil and the second coil includes an outer terminal end and an inner terminal end;
the outer terminal end of the first coil is connected to the first terminal;
the outer terminal end of the second coil is connected to the second terminal; and
the inner terminal end of the first coil and the inner terminal end of the second coil are connected.

6. The inductor device according to claim 4, wherein
each of the first coil and the second coil includes an outer terminal end and an inner terminal end;
the inner terminal end of the first coil is connected to the first terminal;
the inner terminal end of the second coil is connected to the second terminal; and
the outer terminal end of the first coil and the outer terminal end of the second coil are connected.

7. The inductor device according to claim 4, wherein the first coil and the second coil have the same or substantially the same shape and the same or substantially the same dimensions and overlap when seen in a plan view from the direction perpendicular or substantially perpendicular to the substrate.

8. The inductor device according to claim 1, wherein the first coil and the second coil are wound in directions opposite to each other when seen in a plan view from the direction perpendicular or substantially perpendicular to the substrate.

9. The inductor device according to claim 8, wherein
each of the first coil and the second coil includes an outer terminal end and an inner terminal end;
the outer terminal end of the first coil is connected to the first terminal;
the inner terminal end of the second coil is connected to the second terminal; and
the inner terminal end of the first coil and the outer terminal end of the second coil are connected.

10. The inductor device according to claim 8, wherein
each of the first coil and the second coil includes an outer terminal end and an inner terminal end;
the inner terminal end of the first coil is connected to the first terminal;
the outer terminal end of the second coil is connected to the second terminal; and
the outer terminal end of the first coil and the inner terminal end of the second coil are connected.

11. The inductor device according to claim 1, wherein a distance between adjacent conductors is about 0.01 mm or smaller in each of the first coil and the second coil.

12. The inductor device according to claim 1, wherein a distance between adjacent conductors is about 0.002 mm or larger in each of the first coil and the second coil.

13. The inductor device according to claim 1, wherein
the substrate includes a dielectric layer in which a plurality of dielectrics are stacked; and
the first coil and the second coil are provided in layers in the dielectric layer that are different from each other.

14. The inductor device according to claim 13, wherein
the dielectric layer includes a wiring layer therein; and
the first coil and the second coil are provided in the wiring layer.

15. A circuit module comprising:
a substrate;
a plurality of electronic components mounted on the substrate; and
the inductor device according to claim 1; wherein
the substrate includes a support substrate and a wiring layer on the support substrate;
the wiring layer includes wiring to connect the plurality of electronic components to each other; and
the inductor device is provided in the wiring layer.

16. The circuit module according to claim 15, wherein a distance between the first coil and the second coil in the direction perpendicular or substantially perpendicular to the substrate is about 0.1 mm or smaller.

17. The circuit module according to claim 16, wherein the distance between the first coil and the second coil in the direction perpendicular or substantially perpendicular to the substrate is about 0.01 mm or larger.

18. The circuit module according to claim 15, wherein the first coil and the second coil are wound in the same direction when seen in a plan view from the direction perpendicular or substantially perpendicular to the substrate.

19. The circuit module according to claim 18, wherein
each of the first coil and the second coil includes an outer terminal end and an inner terminal end;
the outer terminal end of the first coil is connected to one end of an upper surface of the substrate on which the plurality of electronic components are mounted;
the outer terminal end of the second coil is connected to another end of the upper surface of the substrate on which the plurality of electronic components are mounted; and
the inner terminal end of the first coil and the inner terminal end of the second coil are connected.

20. The circuit module according to claim 18, wherein
each of the first coil and the second coil includes an outer terminal end and an inner terminal end;
the inner terminal end of the first coil is connected to one end of an upper surface of the substrate on which the plurality of electronic components are mounted;
the inner terminal end of the second coil is connected to another end of the upper surface of the substrate on which the plurality of electronic components are mounted; and
the outer terminal end of the first coil and the outer terminal end of the second coil are connected.
